(19) United States
(12) Patent Application Publication
(10) Pub. No.: US 2021/0018474 A1
(43) Pub. Date: Jan. 21, 2021

(54) ASYMMETRIC FLOW FIELD FLOW FRACTIONATION APPARATUS

(71) Applicant: Shimadzu Corporation, Kyoto (JP)

(72) Inventor: Hironobu YAMADA, Kyoto (JP)

(21) Appl. No.: 16/901,804

(22) Filed: Jun. 15, 2020

(30) Foreign Application Priority Data
Jul. 17, 2019 (JP) 2019-131853

(51) Int. Cl. G01N 30/00

(52) U.S. Cl. CPC G01N 30/0005; G01N 2030/003

(57) ABSTRACT

An asymmetric flow field flow fractionation apparatus 1 is provided with a separation cell having a semi-permeable membrane. Each flow path is connected to the separation cell. A mobile phase that has passed through the semi-permeable membrane of the separation cell flows through a crossflow discharge flow path. The crossflow discharge flow path is provided with a flow controller 14 for adjusting the flow rate. A voltage control unit 332 applies a voltage according to a set flow rate to the flow controller 14 when the set flow rate of the mobile phase of the crossflow discharge flow path is constant, and applies a voltage in which an offset is added to the voltage according to the set flow rate to the flow controller 14 to the flow controller 14 when the set flow rate of the crossflow discharge flow path mobile phase increases. Therefore, even if the set flow rate is changed so as to be increased, the flow rate of the mobile phase moving in the crossflow discharge flow path can be changed so as to correspond to the set flow rate.

### CROSS-REFERENCE TO RELATED APPLICATIONS

The present application claims priority under 35 U.S.C. 119 to Japanese Patent Application No. 2019-131853 filed on Jul. 17, 2019, the contents of which are incorporated herein by reference in their entirety.

### BACKGROUND OF THE INVENTION

### Field of the Invention

The present invention relates to an asymmetric flow field flow fractionation apparatus including a separation cell provided with a semi-permeable membrane and configured to classify particles in a liquid sample by applying a flow field to the liquid sample.

### Description of the Related Art

Conventionally, a field flow fractionation apparatus using a crossflow has been used as an asymmetric flow field flow fractionation apparatus for separating fine particles contained in a fluid. A crossflow type field flow fractionation apparatus is provided with a separation cell in which a flow path is formed.

In this field flow fractionation apparatus, a sample in which fine particles which are separation targets are dispersed is introduced into a flow path of a separation cell, and a mobile phase is supplied to the flow path of the separation cell at a predetermined flow rate. Then, while a part of the fluid is flowed out of the separation cell as a crossflow, the fine particles are separated in the separation cell (for example, see Patent Document 1 listed below).

In the field flow fractionation apparatus described in Patent Document 1, in the separation cell, a semi-permeable membrane that allows a mobile phase to pass therethrough but does not allows fine particles to pass therethrough is provided in close contact with the inside of the bottom wall in which a large number of openings is formed. When the mobile phase is supplied to the flow path of the separation cell, a flow of the mobile that passes through the flow path and flows toward a detector and a flow of the mobile phase (crossflow) that passes through the semi-permeable membrane and flows out of the separation cell through the openings of the bottom wall are formed. In the flow path of a separation cell, the distribution of the fine particles according to the particle size is generated by the diffusing of the fine particles and the force by the crossflow, and the flow rate distribution in which the flow rate differs depending on the position of the layer in the thickness direction thereof is generated. As a result, the fine particles flow out sequentially from the outlet of the separation cell in accordance with the particle size. The fine particles flowed out of the separation cell are detected by a detector.

### PRIOR ART DOCUMENT

### Patent Document

Patent Document 1: Japanese Unexamined Patent Application Publication No. 2008-000724

### Problems to be Solved by the Invention

In the case of performing an analysis using a conventional field flow fractionation apparatus as described above, there is a problem that the mobile phase cannot flow through the flow path at a correct flow rate. This problem will be described in detail with reference to FIG. 5. FIG. 5 is a graph showing a temporal change of a flow rate and a temporal change of an applied voltage to a flow controller in a conventional field flow fractionation apparatus.

In the above-described conventional field flow fractionation apparatus, a flow controller for adjusting a flow rate is provided in a flow path (crossflow flow path) passing through a semi-permeable membrane toward an outside of a separation cell. Further, in a field flow fractionation apparatus, a set flow rate is set in advance, and a flow controller is controlled in the operation (a voltage is applied) so that a flow rate of a flow path (crossflow flow path) becomes the set flow rate. In FIG. 5, a temporal change of a flow rate of a mobile phase in a crossflow flow path is shown as a graph E on the upper side, and a temporal change of an applied voltage to the flow controller is shown as a graph F on the lower side.

In the embodiment shown in FIG. 5, the set flow rate E′ is set so as to be kept constant at the beginning of the analysis period, increase at a constant inclination thereafter, and become constant thereafter. That is, in the case of FIG. 5, the set flow rate E′ is not constant at all times, and changes so as to gradually increase in the middle of the analysis period.

In this instance, as shown in graph F, a voltage corresponding to the set flow rate is applied to the flow controller under the control of the control unit. That is, the voltage to the flow controller is kept constant at the beginning of the analysis period, then increased at a constant inclination, and then kept constant.

In contrast, as shown in the graphs E and E′, there is a deviation between the set flow rate E′ and the actual flow rate (E) of the mobile phase in the crossflow flow path. That is, the flow rate (E) of the mobile phase actually flowing through the crossflow flow path deviates from the set flow rate E′.

Specifically, as shown in the graph E, the actual flow rate of the mobile phase in the crossflow flow path is changing so as to be delayed with respect to the change of the set flow rate E′. More specifically, in the graph E, the actual flow rate has start to increase slightly later than the timing when the set flow rate E′ starts to increase. And then, at the timing when the set flow rate E′ becomes constant, the actual flow rate is continuously increasing. The actual flow rate is kept constant from the timing slightly delayed from the timing when the set flow rate E′ becomes constant. As described above, in a conventional field flow fractionation apparatus, in the case of changing the flow rate of the mobile phase (crossflow flow path) passing through the semi-permeable membrane of the separation cell by the flow controller, there arises a problem that the actual flow rate does not correspond to the set flow rate.

### SUMMARY OF THE INVENTION

The present invention has been made in view of the above-described circumstances, and an object thereof is to provide an asymmetric flow field flow fractionation apparatus capable of flowing a mobile phase at a correct flow rate corresponding to a set flow rate.

### Means for Solving the Problem

(1) An asymmetric flow field flow fractionation apparatus according to the present invention is provided with a separation cell, a detector, a first outflow path, a second outflow path, a flow controller, and a control unit. The separation cell is provided with a semi-permeable membrane and configured to classify particles in a liquid sample by applying a flow field to a liquid sample diluted with a mobile phase. The detector is configured to detect the particles in the liquid sample classified by the separation cell. The first outflow path is configured to connect the separation cell and the detector. The second outflow path is configured to flow out the mobile phase in the separation cell through the semi-permeable membrane. The flow controller is configured to control a flow rate of the mobile phase flowing through the second outflow path. The control unit is configured to control an applied voltage to the flow controller. When a set flow rate of the mobile phase in the second outflow path is constant, the control unit applies a voltage corresponding to the set flow rate to the flow controller, and when the set flow rate of the mobile phase in the second outflow path increases, a voltage in which an offset is added to the voltage corresponding to the set flow rate is applied to the flow controller.

In an asymmetric flow field flow fractionation apparatus, when the set flow rate of the mobile phase in the second outflow path increases, if a voltage corresponding to the set flow rate is applied to the flow controller as it is, the flow rate of the mobile phase moving in the second flow path will change so as to be delayed with respect to the change of the set flow rate. That is, when the set flow rate of the mobile phase in the second outflow path increases, if a voltage corresponding to the set flow rate is applied to the flow controller as it is, there will be a deviation between the set flow rate and the flow rate of the mobile phase moving in the second flow path.

According to the asymmetric flow field flow fractionation apparatus of the present invention, when the set flow rate of the mobile phase in the second outflow path increases, a voltage in which an offset is added to the voltage corresponding to the set flow rate is applied to the flow controller.

Therefore, even if the set flow rate is changed so as to be increased, the flow rate of the mobile phase moving in the second flow path can be changed so as to correspond to the set flow rate. Thus, it is possible to suppress the occurrence of the deviation between the set flow rate and the flow rate of the mobile phase moving in the second flow path. As a result, it is possible to flow the mobile phase at a correct flow rate corresponding to the set flow rate in the asymmetric flow field flow fractionation apparatus.

(2) The asymmetric flow field flow fractionation apparatus according to the present invention is provided with a separation cell, a detector, a first outflow path, a second outflow path, a flow controller, and a control unit. The separation cell is provided with a semi-permeable membrane and configured to classify particles in a liquid sample by applying a flow field to a liquid sample diluted with a mobile phase. The detector is configured to detect the particles in the liquid sample classified by the separation cell. The first outflow path is configured to connect the separation cell and the detector. The second outflow path is configured to flow out the mobile phase in the separation cell through the semi-permeable membrane. The flow controller is configured to control a flow rate of the mobile phase flowing through the second outflow path. The control unit is configured to control an applied voltage to the flow controller. When a set flow rate of the mobile phase in the second outflow path is constant, the control unit applies a voltage corresponding to the set flow rate to the flow controller, and when the set flow rate of the mobile phase in the second outflow path decreases, a voltage in which an offset is subtracted from the voltage corresponding to the set flow rate is applied to the flow controller.

In the asymmetric flow field flow fractionation apparatus, when the set flow rate of the mobile phase in the second outflow path decreases, if a voltage corresponding to the set flow rate is applied to the flow controller as it is, the flow rate of the mobile phase moving in the second flow path will change so as to be delayed with the change of the set flow rate. That is, when the set flow rate of the mobile phase in the second outflow path decreases, if a voltage corresponding to the set flow rate is applied to the flow controller as it is, there will be a deviation between the set flow rate and the flow rate of the mobile phase moving in the second flow path.

According to the asymmetric flow field flow fractionation apparatus of the present invention, when the set flow rate of the mobile phase in the second outflow path decreases, a voltage in which an offset is subtracted from the voltage corresponding to the set flow rate is applied to the flow controller.

Therefore, even if the set flow rate is changed so as to be reduced, the flow rate of the mobile phase moving in the second flow path can be changed so as to correspond to the set flow rate. Thus, it is possible to suppress the occurrence of a deviation between the set flow rate and the flow rate of the mobile phase moving in the second flow path. As a result, in the asymmetric flow field flow fractionation apparatus, it is possible to flow the mobile phase at a correct flow rate corresponding to the set flow rate.

(3) The offset may be a value proportional to the change rate of the set flow rate.

According to such a configuration, when the set flow rate changes greatly, a voltage can be applied to the flow controller by increasing the offset. Further, when the set flow rate changes small, it is possible to apply a voltage to the flow controller by reducing the offset.

Therefore, it is possible to apply a voltage to the flow controller with high accuracy so that the set flow rate and the flow rate of the mobile phase moving in the second flow path correspond to each other. As a result, in the asymmetric flow field flow fractionation apparatus, it is possible to flow the mobile phase at a correct flow rate.

### Effects of the Invention

According to the present invention, when the set flow rate of the mobile phase in the second outflow path increases, a voltage in which an offset is added to the voltage corresponding to the set flow rate is applied to the flow controller. Therefore, even if the set flow rate is changed so as to increase, it is possible to change the flow rate of the mobile phase moving in the second flow path so as to correspond to the set flow rate. When the set flow rate of the mobile phase in the second outflow path decreases, a voltage in which an offset is subtracted from a voltage corresponding to the set flow rate is applied to the flow controller. Therefore, even if the set flow rate is changed so as to be reduced, the flow rate of the mobile phase moving the second flow path can be changed so as to correspond to the set flow rate. As a result, in the asymmetric flow field flow fractionation apparatus, it is possible to flow the mobile phase at the correct flow rate corresponding to the set flow rate.

### BRIEF DESCRIPTION OF THE DRAWINGS

FIG. 1 is a schematic diagram showing a configuration example of an asymmetric flow field flow fractionation apparatus according to a first embodiment of the present invention.

FIG. 2 is a block diagram showing an electric configuration of a control unit and its peripheral members.

FIG. 3 is a graph showing a temporal change of a flow rate in a crossflow discharge flow path and a temporal change of an applied voltage to a flow controller in an asymmetric flow field flow fractionation apparatus of FIG. 1.

FIG. 4 is a graph showing a temporal change of a flow rate in a crossflow discharge flow path and a temporal change of an applied voltage to a flow controller in an asymmetric flow field flow fractionation apparatus of a second embodiment of the present invention.

FIG. 5 is a graph showing a temporal change of a flow rate and a temporal change of an applied voltage to a flow controller in a conventional field flow fractionation apparatus.

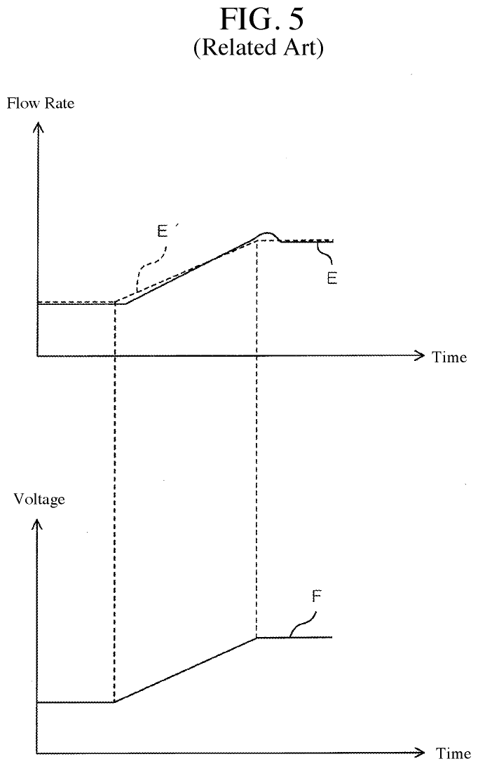

### EMBODIMENTS FOR CARRYING OUT THE INVENTION

### 1. General Configuration of Asymmetric Flow Field Flow Fractionation Apparatus

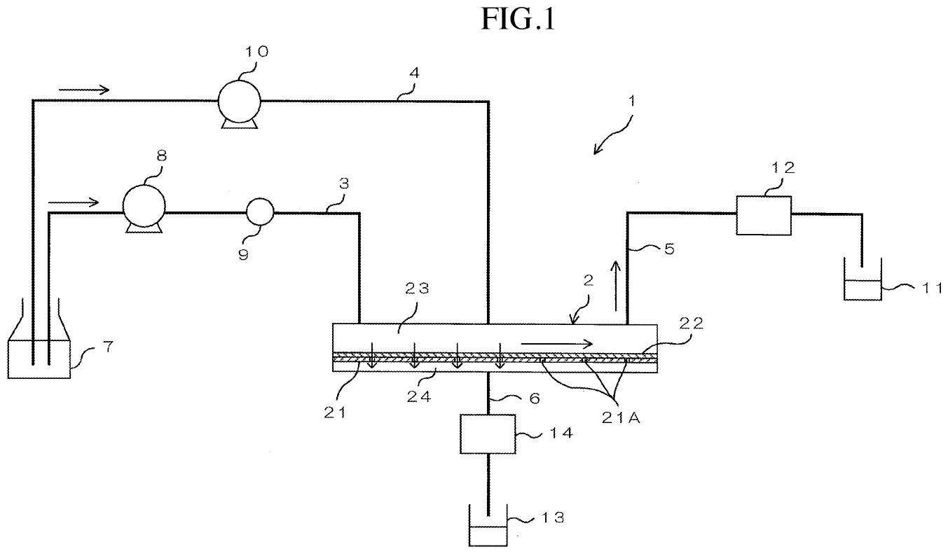

FIG. 1 is a schematic diagram showing a configuration example of an asymmetric flow field flow fractionation apparatus 1 according to a first embodiment of the present invention.

The asymmetric flow field flow fractionation apparatus 1 is provided with a separation cell 2. The asymmetric flow field flow fractionation apparatus 1 is provided with, as flow paths, a carrier flow path 3, a focus flow path 4, an outflow path 5, and a crossflow discharge flow path 6.

The separation cell 2 is formed in an elongated hollow shape. A support wall 21 is provided inside the separation cell 2. The support wall 21 is arranged between the top wall and the bottom wall of the separation cell 2 and is arranged in parallel thereto. The support wall 21 partitions the interior space of the separation cell 2 into upper and lower two regions. A plurality of openings 21A is formed in the support wall 21. On the upper surface of the support wall 21, a semi-permeable membrane 22 is provided (is in close contact therewith).

The semi-permeable membrane 22 is a film that allows a fluid to pass therethrough but does not allow fine particles to pass therethrough. The plurality of openings 21A of the support wall 21 is covered by the semi-permeable membrane 22. With such a configuration, the inside of the separation cell 2 is partitioned into a first cell flow path 23 partitioned by the upper wall and the support wall 21 (semi-permeable membrane 22) and a second cell flow path 24 partitioned by the bottom wall and the support wall 21.

One end of the carrier flow path 3 is connected to one end of the separation cell 2. The one end of the carrier flow path 3 is in communication with the first cell flow path 23 formed in the separation cell 2. The other end of the carrier flow path 3 is arranged within a fluid supply portion 7. In the fluid supply portion 7, a fluid to be served as a mobile phase is stored. In the middle of the carrier flow path 3, a first pump 8 and a sample introduction portion 9 are arranged (interposed) in this order in the moving direction of the carrier fluid (mobile phase).

The sample introduction portion 9 is, for example, an auto-sampler. One end of the focus flow path 4 is connected to the center of the separation cell 2. The one end of the focus flow path 4 is communicated with the first cell flow path 23 formed in the separation cell 2. The other end of the focus flow path 4 is arranged within the fluid supply portion 7. A second pump 10 is arranged (interposed) in the middle of the focus flow path 4.

One end of the outflow path 5 is connected to the other end of the separation cell 2. The one end of the outflow path 5 is communicated with the first cell flow path 23 formed in the separation cell 2. The other end of the outflow path 5 is arranged within the drain 11. The middle portion of the outflow path 5, a detector 12 is arranged (interposed). The outflow path 5 is an example of the first outflow path.

One end of the crossflow discharge flow path 6 is connected to the lower end of the separation cell 2. The one end of the crossflow discharge flow path 6 is communicated with the second cell flow path 24 formed in the separation cell 2. The other end of the crossflow discharge flow path 6 is arranged within a drain 13. At the middle portion of the crossflow discharge flow path 6, a flow controller 14 is arranged (interposed). The crossflow discharge flow path 6 is an example of the second outflow path.

The flow controller 14 is configured to control the flow rate of the mobile phase flowing through the crossflow discharge flow path 6 by being applied by a voltage.

When separating the sample (fine particles) in the asymmetric flow field flow fractionation apparatus 1, the first pump 8 and the second pump 10 are operated to form a flow of the mobile phase (carrier fluid) from the fluid supply portion 7 to the separation cell 2 via the carrier flow path 3 and a flow of the mobile phase (focus fluid) from the fluid supply portion 7 to the separation cell 2 via the focus flow path 4. Further, the sample introduction portion 9 is operated to introduce a sample containing a plurality of fine particles of various particle sizes into the carrier flow path 3. The sample introduced by the sample introduction portion 9 is diluted by a mobile phase. A fluid containing the sample and the mobile phase is a liquid sample.

By introducing the carrier fluid and the focus fluid into the separation cell 2, the fine particles contained in the liquid sample are collected in a part of the first cell flow path 23. Further, in the separation cell 2, a crossflow is generated in which the mobile phase in the first cell flow path 23 is directed to the second cell flow path 24 through the openings 21A of the support wall 21. The flow rate of the crossflow is adjusted by operating the flow controller 14. As a result, a fine particle distribution corresponding to the particle size of the fine particles is generated in the first cell flow path 23. Specifically, a particle distribution occurs in which the particles larger in particle size are positioned on the lower side in the first cell flow path 23 and the particles smaller in particle size are positioned on the center side of the first cell flow path 23.

From this state, the operation of the second pump 10 is stopped (i.e. the pressures of the first pump 8 and the second pump 10 are changed). With this, in the first cell flow path 23, a flow towards the outflow path 5 occurs (a flow field is given). Then, in the separation cell 2, fine particles flow according to the particle size, so that the fine particles are separated. The fine particle separated for each particle size sequentially flows out to the outflow path 5 (the particles in the liquid sample are classified) and detected by the detector 12. The liquid sample discharged from the outflow path 5 is collected by the drain 11, and the fluid (mobile phase) flowing as a crossflow is collected by the drain 13 via the crossflow discharge flow path 6.

### 2. Electrical Configuration of Control Unit and its Surrounding Components

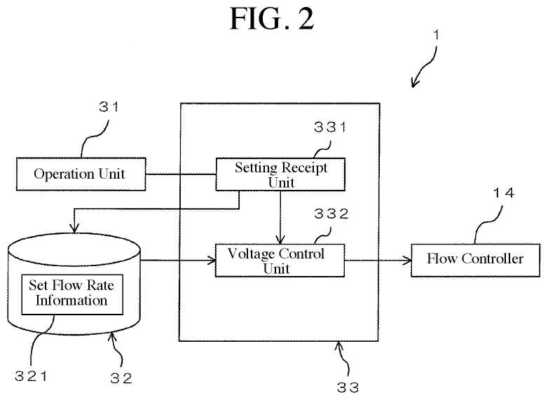

FIG. 2 is a diagram showing the electric configuration of the control unit 33 and its peripheral members. In addition to the above-described flow controller 14, the asymmetric flow field flow fractionation apparatus 1 is provided with an operation unit 31, a storage unit 32, and a control unit 33.

The operation unit 31 is configured to include, for example, a keyboard and a mouse.

The storage unit 32 is composed of, for example, a ROM (Read Only Memory), a RAM (Random Access Memory), and a hard disk. Set flow rate information 321 is stored in the storage unit 32. The set flow rate information 321 is the information of a set flow rate of the crossflow discharge flow path 6 with respect to the flow rate of the asymmetric flow field flow fractionation apparatus 1.

The control unit 33 is configured to include a CPU (Central Processing Unit). Each of the flow controller 14, the operation unit 31, and the storage unit 32 is electrically connected to the control unit 33. The control unit 33 functions as a setting reception unit 331 and a voltage control unit 332 when the CPU executes programs.

The setting reception unit 331 accepts the setting of the flow rate of the mobile phase in the asymmetric flow field flow fractionation apparatus 1 according to the operation of the operation unit 31 by a user.

The voltage control unit 332 performs processing of controlling the voltage to be applied to the flow controller 14 based on the set flow rate information 321 of the storage unit 32.

### 3. Control Operation of Control Unit

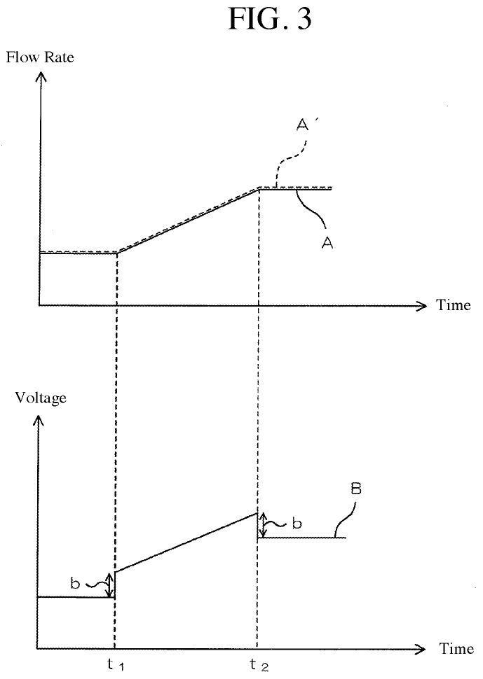

FIG. 3 is a graph showing a temporal change of a flow rate in the crossflow discharge flow path 6 and a temporal change of an applied voltage to the flow controller 14 in the asymmetric flow field flow fractionation apparatus 1. In FIG. 3, on the upper side, a temporal change of a flow rate of a mobile phase in the crossflow discharge flow path 6 is shown as a graph A, and on the lower side, a temporal change of an applied voltage to the flow controller 14 is shown as a graph B.

When analyzing a sample using the asymmetric flow field flow fractionation apparatus 1, the user first operates the operation unit 31 to set the flow rate of each flow path. Specifically, the user sets the flow rate of each of the carrier flow path 3 and the crossflow discharge flow path 6. As described above, in the analysis using the asymmetric flow field flow fractionation apparatus 1, since the second pump 10 is stopped, the flow rate of the focus flow path 4 is not set. Further, the flow rate of the outflow path 5 is set to be constant at all times.

In this example, it is assumed that each flow rate of the carrier flow path 3 and the crossflow discharge flow path 6 is set to be increased. Specifically, in this example, it is assumed that the set flow rate of the carrier flow path 3 and the set flow rate of the crossflow discharge flow path 6 are set by the user to remain constant at the beginning of the analysis period, then increase at a constant inclination, and then become constant. On the upper part of FIG. 3, the set flow rate of the crossflow discharge flow path 6 thus set is indicated by a dotted line (A′).

The setting reception unit 331 accepts the flow rate setting for each flow path (the carrier flow path 3 and the crossflow discharge flow path 6) according to the operation of the operation unit 31 by a user. At this time, the setting reception unit 331 stores the accepted set flow rate of the crossflow discharge flow path 6 in the storage unit 32 as the set flow rate information 321. This set flow rate information 321 corresponds to the graph A′.

In the asymmetric flow field flow fractionation apparatus 1, the first pump 8 and the flow controller 14 are operated in accordance with the set flow rate received by the setting reception unit 331. Note that as described above, the operation of the second pump 10 is stopped.

The voltage control unit 332 reads out the set flow rate information 321 and controls the voltage to be applied to the flow controller 14 based on the read set flow rate information 321. At this time, the voltage control unit 332 performs control so as to keep the voltage to be applied to the flow controller 14 constant during the period in which the value of the set flow rate is continuously constant in the set flow rate information 321. The voltage control unit 332 controls so that a voltage having a constant inclination corresponding to the inclination of the value of the set flow rate increasing at a constant inclination is applied to the flow controller 14 in which an offset (correction value) is added during the period during which the value of the set flow rate increases at a constant inclination, in the set flow rate information 321. That is, the voltage control unit 332 controls so that a voltage having an inclination corresponding to the change in which an offset (correction value) is added during the period during which the value of the set flow rate changes in the set flow rate information 321 is applied to the flow controller 14.

Specifically, as shown in FIG. 3, the set flow rate A′ is constant in the period up to t₁ and the period after t₂. In this period, the voltage to be applied to the flow controller 14 by the voltage control unit 332 is constant. Further, the set flow rate A′ increases at a constant inclination during the period from t₁ to t₂. In this period, the voltage to be applied to the flow controller 14 by the voltage control unit 332 has a constant inclination corresponding to the inclination of the set flow rate A′ and is a value in which the offset b is added.

The offset b is a value proportional to the change rate (inclination of the set flow rate A′). In other words, when the change rate (inclination) of the set flow rate A′ is small, the value of the offset b becomes small, while the change rate (inclination of the set flow rate A′) is large, the offset b becomes large.

As described above, as a result that the applied voltage to the flow controller 14 is appropriately changed, as shown in the graph A, the actual flow rate of the crossflow discharge flow path 6 coincides with the set flow rate A′. That is, in the crossflow discharge flow path 6, the flow rate set as the set flow rate A′ is maintained.

### 4. Effects

(1) According to this embodiment, the asymmetric flow field flow fractionation apparatus 1 is provided with the separation cell 2 having the semi-permeable membrane 22. Each flow path (the carrier flow path 3, the focus flow path 4, the outflow path 5, and the crossflow discharge flow path 6) is connected to the separation cell 2. The mobile phase that has passed through the semi-permeable membrane 22 of the separation cell 2 flows through the crossflow discharge flow path 6. The crossflow discharge flow path 6 is provided with the flow controller 14 for adjusting its flow rate. As shown in FIG. 3, the voltage control unit 332 applies a voltage corresponding to the set flow rate A′ to the flow controller 14 when the set flow rate A′ of the mobile phase of the crossflow discharge flow path 6 is constant, and applies a voltage corresponding to the set flow rate A′ in which an offset b is added to the flow controller 14 when the set flow rate A′ of the crossflow discharge flow path 6 of the mobile phase increases.

Therefore, even if the flow rate A′ is changed so as to be increased, it is possible to change so that the flow rate of the mobile phase moving through the crossflow discharge flow path 6 changes so as to correspond to (coincided with) the set flow rate A′. Thus, it is possible to suppress the occurrence of a deviation between the set flow rate A′ and the flow rate of the mobile phase moving the crossflow discharge flow path 6. As a result, it is possible to flow the mobile phase at the correct flow rate corresponding to the set flow rate A′ in the crossflow discharge flow path 6 of the asymmetric flow field flow fractionation apparatus 1.

(2) According to this embodiment, as shown in FIG. 3, the voltage applied to the flow controller 14 by the voltage control unit 332 has a constant inclination corresponding to the inclination of the set flow rate A′ and is a value in which an offset b is added. The offset b is a value proportional to the change rate (inclination of the set flow rate A′).

In other words, when the change rate (inclination) of the set flow rate A′ is small, the value of the offset b becomes small, while when the change rate (inclination) of the set flow rate' is large, the offset b becomes large.

For this reason, it is possible to apply a voltage to the flow controller 14 with high accuracy by the voltage control unit 332 so that the set flow rate A′ and the flow rate of the mobile phase moving through the crossflow discharge flow path 6 correspond to each other. As a result, it is possible to flow the mobile phase at the correct flow rate in the crossflow discharge flow path 6 of the asymmetric flow field flow fractionation apparatus 1.

### 5. Modification

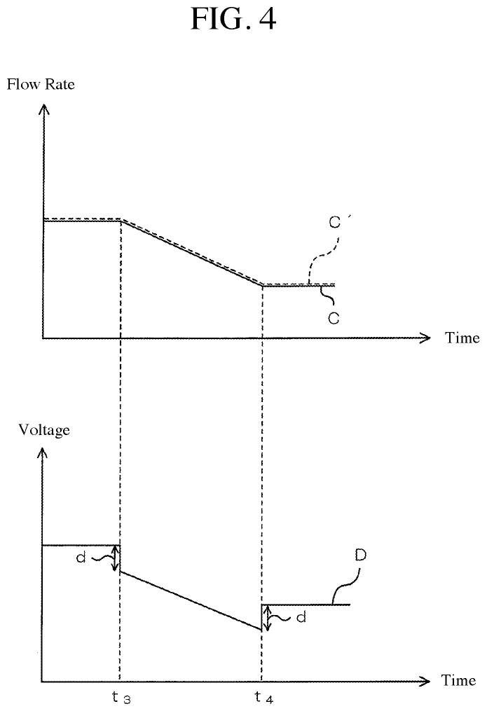

Hereinafter, an asymmetric flow field flow fractionation apparatus 1 according to a second embodiment of the present invention will be described with reference to FIG. 4. It should be noted that the same reference numerals as those described above are used to omit descriptions of the same components as those of the first embodiment.

FIG. 4 is a graph showing a temporal change of a flow rate in the crossflow discharge flow path 6 and a temporal change of an applied voltage to the flow controller according to an asymmetric flow field flow fractionation apparatus 1 of a second embodiment of the present invention.

In the above-described embodiment, when the set flow rate of the mobile phase of the crossflow discharge flow path 6 increases, the voltage control unit 332 applies a voltage in which an offset is added to the voltage corresponding to the set flow rate.

On the other hand, in the second embodiment, when the set flow rate of the mobile phase of the crossflow discharge flow path 6 decreases, the voltage control unit 332 applies a voltage in which an offset is subtracted from the voltage corresponding to the set flow rate.

In FIG. 4, on the upper side, the temporal change of the flow rate of the mobile phase in the crossflow discharge flow path 6 is shown as a graph C, and on the lower side, the temporal change of the applied voltage to the flow controller 14 is shown as a graph D.

When performing an analysis of a sample using the asymmetric flow field flow fractionation apparatus 1, the user first operates the operation unit 31 to set the flow rate of each of the carrier flow path 3 and the crossflow discharge flow path 6.

In the second embodiment, the user sets each flow rate of the carrier flow path 3 and the crossflow discharge flow path 6 to be reduced. Specifically, in the second embodiment, a user sets the set flow rate of the carrier flow path 3 and the set flow rate of the crossflow discharge flow path 6 to keep constant at the beginning of the analysis period, then decrease at a constant inclination, and then keep constant. In the upper side of FIG. 4, the set flow rate of the crossflow discharge flow path 6 is indicated by a dotted line C′.

The setting reception unit 331 accepts the flow rate setting for each flow path (the carrier flow path 3 and the crossflow discharge flow path 6) according to the operation of the operation unit 31 by the user. At this time, the setting reception unit 331 stores the accepted set flow rate of the crossflow discharge flow path 6 in the storage unit 32 as the set flow rate information 321. In the second embodiment, the set flow rate information 321 corresponds to the graph C′. In the asymmetric flow field flow fractionation apparatus 1, the first pump 8 and the flow controller 14 are operated in accordance with the set flow rate received by the setting reception unit 331.

The voltage control unit 332 reads out the set flow rate information 321 and controls the voltage to be applied to the flow controller 14 based on the read set flow rate information 321. At this time, the voltage control unit 332 performs control so as to keep the voltage to be applied to the flow controller 14 constant in a period during which the value of the set flow rate is continuously constant in the set flow rate information 321. The voltage control unit 332 controls, during the period during which the value of the set flow rate is continuously constant in the set flow rate information 321, that a voltage having a constant inclination corresponding to the inclination and subtracted by an offset (correction value) is applied to the flow controller 14. That is, the voltage control unit 332 controls, in a period during which the value of the set flow rate changes in the set flow rate information 321, that a voltage having an inclination corresponding to the change and subtracted by the offset (correction value) is applied to the flow controller 14.

Specifically, as shown in the graph of FIG. 4, the set flow rate C′ is constant in the period up to t₃ and the period after t₄. In this period, the voltage to be applied to the flow controller 14 by the voltage control unit 332 is constant. Further, the set flow rate C′ decreases at a constant inclination in the time period from t₃ to t₄. In this period, the voltage to be applied to the flow controller 14 by the voltage control unit 332 has a constant inclination corresponding to the inclination of the set flow rate C′ and has a value in which the offset d is subtracted.

This offset d is a value proportional to the change rate (inclination) of the set flow rate C′. In other words, when the change rate (inclination) of the set flow rate C′ is small, the value of the offset d becomes small, while when the change rate (inclination) of the set flow rate C′ is large, the offset d becomes large.

As shown in graph C, the actual flow rate of the crossflow discharge flow path 6 coincides with the set flow rate C′ as a result of the arbitrarily changed applied voltage to the flow controller 14. That is, in the crossflow discharge flow path 6, the flow rate set as the set flow rate C′ is secured.

As described above, in the second embodiment, the voltage control unit 332 applies a voltage corresponding to the set flow rate C′ to the flow controller 14 when the set flow rate C′ of the mobile phase in the crossflow discharge flow path 6 is constant, and applies a voltage in which an offset d is subtracted from the voltage corresponding to the set flow rate C′ to the controller 14 when the set flow rate C′ of the mobile phase of the crossflow discharge flow path 6 decreases.

Therefore, even if the set flow rate C′ is changed so as to be decreased, it is possible to change the flow rate of the mobile phase moving the crossflow discharge flow path 6 so as to correspond to (coincide with) the set flow rate C′. It is also possible to suppress the deviation between the set flow rate C′ and the flow rate of the mobile phase moving the crossflow discharge flow path 6. As a result, it is possible to flow the mobile phase at the correct flow rate corresponding to the set flow rate C′ in the crossflow discharge flow path 6 of the asymmetric flow field flow fractionation apparatus 1.

Further, in the second embodiment, the voltage to be applied to the flow controller 14 by the voltage control unit 332 has a constant inclination corresponding to the inclination of the set flow rate C′ and is a value in which the offset d is subtracted, as shown in FIG. 4. This offset d is a value proportional to the change rate (inclination) of the set flow rate C′.

In other words, when the change rate (inclination) of the set flow rate C′ is small, the value of the offset d becomes small, while when the change rate (inclination) of the set flow rate C′ is large, the value of the offset b becomes large.

Therefore, it is possible to apply a voltage to the flow controller 14 with high accuracy by the voltage control unit 332 so that the set flow rate C′ and the flow rate of the mobile phase moving in the crossflow discharge flow path 6 correspond to each other. As a result, it is possible to flow the mobile phase at the correct flow rate in the crossflow discharge flow path 6 of asymmetric flow field flow fractionation apparatus 1.

1. An asymmetric flow field flow fractionation apparatus comprising:
a separation cell provided with a semi-permeable membrane and configured to classify particles in a liquid sample by applying a flow field to a liquid sample diluted with a mobile phase;
a detector configured to detect the particles in the liquid sample classified by the separation cell;
a first outflow path configured to connect the separation cell and the detector;
a second outflow path configured to flow out the mobile phase in the separation cell through the semi-permeable membrane;
a flow controller configured to control a flow rate of the mobile phase flowing through the second outflow path; and
a control unit configured to control an applied voltage to the flow controller,
wherein when a set flow rate of the mobile phase in the second outflow path is constant, the control unit applies a voltage corresponding to the set flow rate to the flow controller, and when the set flow rate of the mobile phase in the second outflow path increases, a voltage in which an offset is added to the voltage corresponding to the set flow rate is applied to the flow controller.

2. An asymmetric flow field flow fractionation apparatus comprising:
a separation cell provided with a semi-permeable membrane and configured to classify particles in a liquid sample by applying a flow field to a liquid sample diluted with a mobile phase;
a detector configured to detect the particles in the liquid sample classified by the separation cell;
a first outflow path configured to connect the separation cell and the detector;
a second outflow path configured to flow out the mobile phase in the separation cell through the semi-permeable membrane;
a flow controller configured to control a flow rate of the mobile phase flowing through the second outflow path; and
a control unit configured to control an applied voltage to the flow controller,
wherein when a set flow rate of the mobile phase in the second outflow path is constant, the control unit applies a voltage corresponding to the set flow rate to the flow controller, and when the set flow rate of the mobile phase in the second outflow path decreases, a voltage in which an offset is subtracted from the voltage corresponding to the set flow rate is applied to the flow controller.

3. The asymmetric flow field flow fractionation apparatus as recited in claim 1,
wherein the offset is a value proportional to a change rate of the set flow rate.

4. The asymmetric flow field flow fractionation apparatus as recited in claim 2,
wherein the offset is a value proportional to a change rate of the set flow rate.
